(19) United States
(12) Patent Application Publication
(10) Pub. No.: US 2008/0087726 A1
(43) Pub. Date: Apr. 17, 2008

(54) APPARATUS AND METHOD FOR TRACKING OF NEONATE FEEDING SUBSTRATE

(76) Inventors: Scott A. Norman, Overland Park, KS (US); Mark A. Petheram, Overland Park, KS (US)

Correspondence Address: SHUGHART THOMSON & KILROY, PC, 120 WEST 12TH STREET, KANSAS CITY, MO, 64105, US

(21) Appl. No.: 11/872,475

(22) Filed: Oct. 15, 2007

Related U.S. Application Data
(63) Continuation-in-part of application No. 11/849,041, filed on Aug. 31, 2007.
Application No. 11/849,041 is a continuation-in-part of application No. 11/801,142, filed on May 9, 2007.
(60) Provisional application No. 60/851,936, filed on Oct. 16, 2006.

(51) Int. Cl. G06Q 90/00

(52) U.S. Cl. 235/385

(57) ABSTRACT

An apparatus and method are provided employing radio frequency identification and temperature detection tags to monitor the identification and temperature and the transfer and the storage of neonate feeding substrates such as neonate formula or breast milk and the like throughout a hospital and neonate care unit the apparatus includes a refrigeration and a heating and cooling unit for storing and making temperature modifications to the to neonate feeding substrate and which apparatus are used in the tracking of the substrate during the course of warming and/or refrigeration and/or transport of the substrate to different locations within a hospital or hospital neonate intensive care unit.

### CROSS REFERENCE TO RELATED APPLICATION

This application is a continuation-in-part of application Ser. No. 11/849,041 filed Aug. 31, 2007, titled Neonatal Nutrition Warmer and which is a continuation-in-part of application Ser. No. 11/801,142 filed May 9, 2007, Titled Neonatal Nutrition Warmer the specification of each is incorporated herein by reference. This application claims priority under 35 U.S.C. 119(e) and 37 C.F.R. 1.78(a)(4) based upon copending U.S. Provisional Application Ser. No. 60/851,936 for Warmer and Cooler for Bottled Liquid filed Oct. 16, 2006 and which is incorporated herein by reference.

### FIELD OF THE INVENTION

The apparatus and method comprise the use of RFID tags to monitor the temperature and transfer and storage of infant formula or breast milk and other types of neonate feeding substrates as it is utilized throughout a hospital and neonate care unit. The embodiments described herein generally present an apparatus and method for providing refrigeration and heating to neonate formula or feeding substrate, including breast milk, and detecting the container identity and temperature of the formula or breast milk during the course of its warming and/or refrigeration and/or transport to different locations within a hospital or hospital neonate intensive care unit and during the warming of the substrate to a usable temperature for feeding an infant and the handling associated therewith.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a front, top and left side perspective view of an embodiment of the refrigeration unit;

FIG. 2 is a front, top and left side perspective view of the refrigeration unit having a neonatal substrate warmer and cooler unit connected thereto;

FIG. 3 is a front elevation view of a container for a neonate feeding substrate, such as breast milk or formula, having an RFID tag connected thereto;

FIG. 4 is a front, top and right side perspective view of a neonatal feeding syringe having an RFID tag connected thereto;

FIG. 5 is a flowchart showing the method described herein of tracking neonatal substrate throughout a hospital and/or neonate intensive care unit;

FIG. 6 is a flowchart showing the verification method described herein for determining that a neonate feeding substrate is at the proper conditions for feeding to a neonate; and

FIG. 7 is a schematic representation of the various storage and parameter checking options that may be employed during the tracking neonatal substrate.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

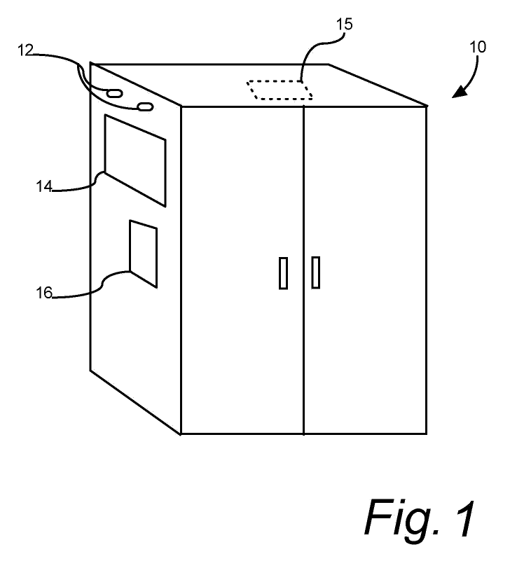

First referring to FIG. 1, the present system and its embodiments utilize a refrigeration unit 10 which is equipped with computer data ports 12 which can be, for example, a USB port and cord for transmitting information collected by the refrigeration unit 10 to other apparatus. Refrigeration unit 10 is also equipped with onboard display 14, such as a liquid crystal display (LCD), which permits display of the current RFID detected contents of the refrigerator while avoiding the opening of the refrigerator to determine whether or not the container of infant formula sought is actually within refrigerator 10. Refrigerator 10 is provided with an RFID tag reader 15 which, in a preferred embodiment, is affixed to the refrigerator 10. The RFID reader 15 reads the RFID tag indicia of containers being placed into refrigerator 10 and is activated by the opening of doors 11 of refrigerator 10. In this manner reader 15 will detect the removal from the refrigerator or the addition to the refrigerator of any neonate feeding substrate container that is equipped with an RFID tag as taught hereinafter. The information detected by reader 15 is displayed on LCD 14. Reader 15 also can be activated by use of keypad 16 to read the RFID tags of the containers within refrigerator 10 without the need to open the refrigerator doors 11. LCD display 14 presents to the operator of refrigerator 10 other data and information which can be downloaded to refrigerator 10 via data port 12 which connects refrigerator 10 to the hospital or neonate intensive care unit (neonate ICU) database. It will be appreciated by those skilled in the art that in the interests of maintaining security through the generally non-secure hospital environment that refrigerator 10, equipped with keypad 16, can require a user to enter access codes to allow entry into refrigerator 10 or to read information on the LCD. It will also be appreciated that keypad 16 can include any of several types of magnetic stripe or other typical security devices which would not only allow access to refrigerator 10, but which may also record the identity of the individual obtaining access to refrigerator 10. The neonate substrate containers described hereinafter can be kept within refrigerator 10 at the required refrigeration temperatures of 2-6 degrees Centigrade (35-43 degrees Fahrenheit).

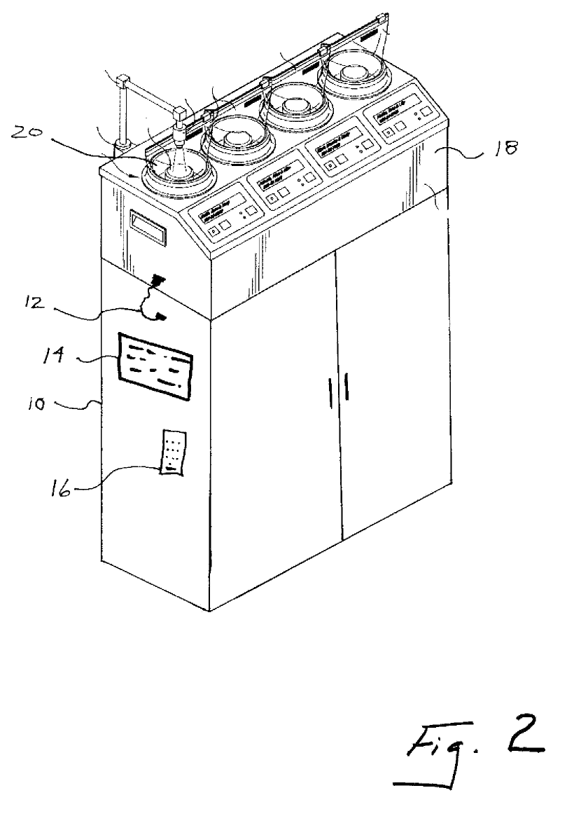

In FIG. 2, an embodiment of refrigerator 10 is shown connected to a neonate substrate warmer and cooler unit 18 which is designed to fit a top refrigerator 10. Warmer and cooler unit 18 is provided with one or more wells 20 into which a container of neonate feeding substrate can be placed and warmed or cooled according to operations and principals previously described in U.S. patent application Ser. No. 11/801,142 filed May 9, 2007 entitled Neonatal Nutrition Warmer and U.S. patent application Ser. No. 11/849,041 filed Aug. 31, 2007 entitled Neonatal Nutrition Warmer. As will be described hereinafter, refrigerator 10 is also part of an entire system of monitoring containers of infant formula or breast milk through the use of radio frequency identification tags that also provide temperature monitoring through the RFID tags.

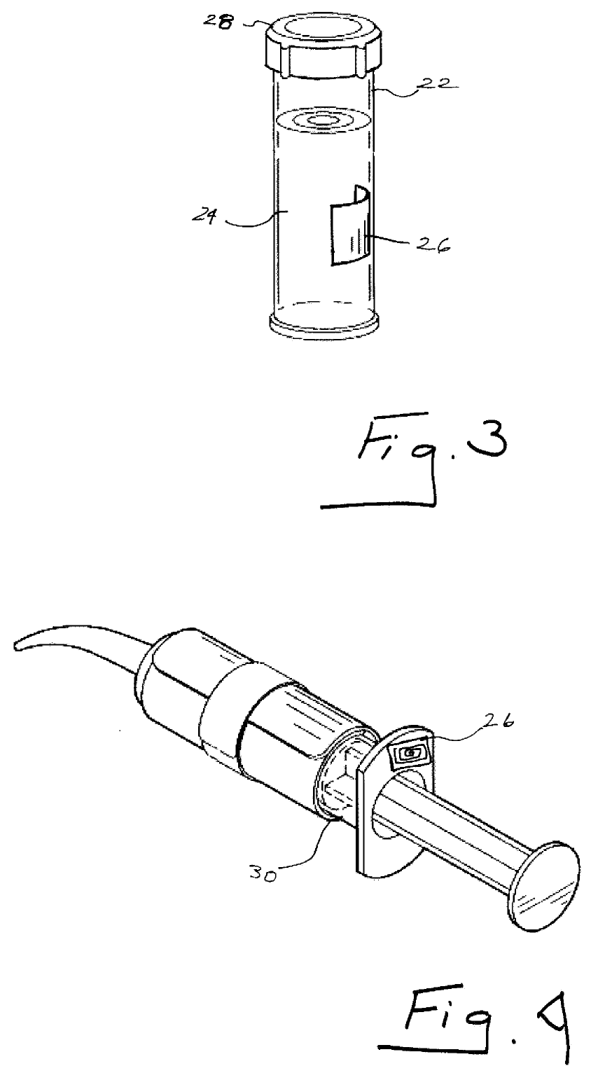

Referring now to FIGS. 3 and 4, two typical containers for holding breast milk or infant formula generally referred to herein as neonate feeding substrate or as substrate are shown. In FIG. 3, a container 22 is shown containing substrate 24 therein and having a radio frequency identification tag (RFID tag) 26 connected to container 22. It will be appreciated by those skilled in the art that RFID tag 26 can be within container 22 or attached to any portion of container 22. However, it is likely that RFID tag 26 will not be within removable cap 28 where the cap is separable from container 22. It will be further appreciated that a duplicate tag 26 could be attached to cap 28 thereby avoiding this difficulty. Referring now to FIG. 4, an alternate container for holding neonate substrate is shown in the form of a feeding syringe 30 having an RFID tag 26 attached thereto. These two containers have been discussed in greater detail in application Ser. No. 11/801,142 filed May 9, 2007 and Ser. No. 11/849,041, filed Aug. 31, 2007 the contents of which are incorporated herein by reference thereto.

Once the containers have been provided with RFID and entered into the tracking system as described hereinafter, the containers either may be placed in neonate unit tracking refrigeration unit 10 (FIG. 1) where they are available for immediate use or the containers 22 may be placed into an individual infant refrigeration unit 10 (FIG. 2) having a single or multiple well cooling and warming unit 18 associated therewith.

Referring again to FIG. 2, it will be appreciated that when formula is placed into either warming or cooling unit 18 or into refrigerator 10, the two devices are interconnected by data cable 12 and are able to share information which allows the data storage on refrigerator 10 to be updated when a particular container having formula therein is introduced into warmer cooler 18 to thereby record the warming or cooling process that is conducted by unit 18 and to maintain a log of the temperatures at which the infant formula or breast milk 24 is subjected. Again, it will be appreciated by those skilled in the art that refrigerator 10 and warmer unit 18, while being interconnected with one another, also may be interconnected to a data system of the neonate unit and that the information tracked from refrigeration unit 10 or warmer unit 18 will thereby become a part of the permanent log of the identity and temperature records of the container 22 being tracked.

After the neonate substrate 24 has been warmed to the appropriate temperature using warmer 18 (FIG. 2), the container 22 can be removed and taken to the infant for feeding of the formula to the infant at step 126. It will be appreciated that just prior to feeding at step 126, the data is once again obtained, verified and recorded at step 118. After feeding has been completed, data regarding the container and formula is again tracked at step 130, at which point the end temperature after the feeding cycle can be recorded, the identity of the container can be recorded, and the time and date of the particular feeding can be recorded prior to the container being discarded at step 128 and the log for that particular container brought to a conclusion.

As a result of the system and apparatus described herein, it will be seen that apparatus and apparatus and method for tracking the identification and temperature of the substrate is provided so that the condition of the substrate can be determined at any time between the date of collection and the time of feeding of the infant. It will also be appreciated that the system receiving the tracking data as well as the individual RFID tags can be equipped with alarms which are set to call attention to the particular container should the temperature of the substrate in that container ever be detected to be beyond the temperature limits previously described of 2-6 degrees Centigrade (35-43 degrees Fahrenheit). It will be appreciated that the alarm could be a sound alarm or a flashing light alarm which could be observed from any of the tracking stations or refrigerator 10 or warmer 18 or the RFID tag 26 itself could be equipped with a small LED which would light up upon an out of range temperature being detected. Such an onboard LED could receive power from the small battery contained in a semi-passive RFID tag or the radio frequency energy received by the tag during the reading of a passive RFID tag may be sufficient to cause the LED to eliminate.

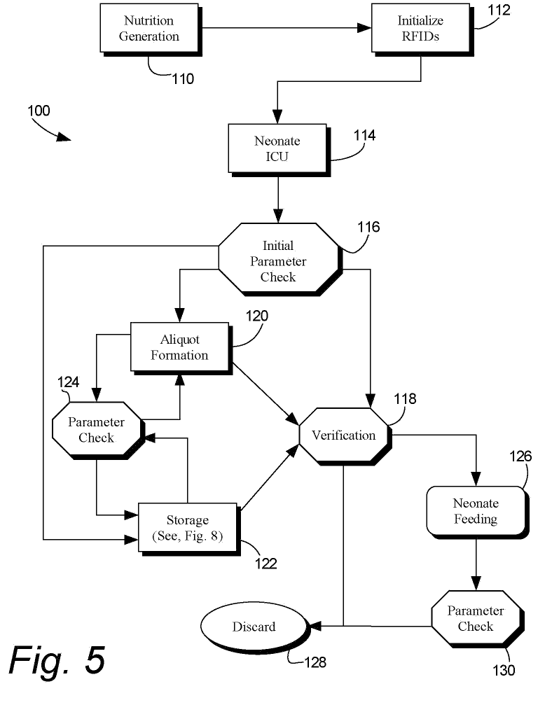

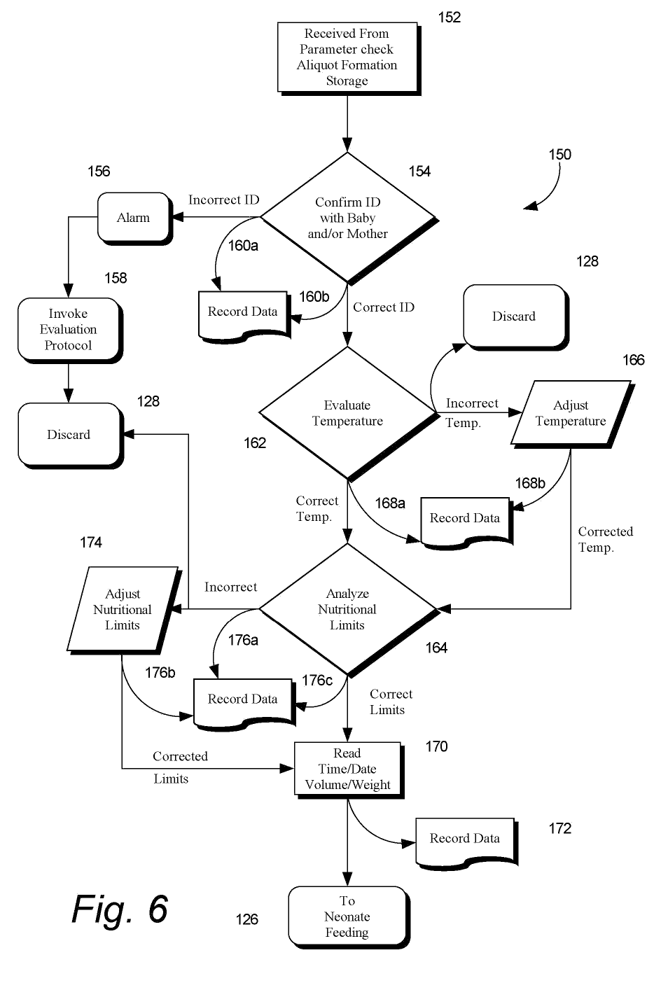

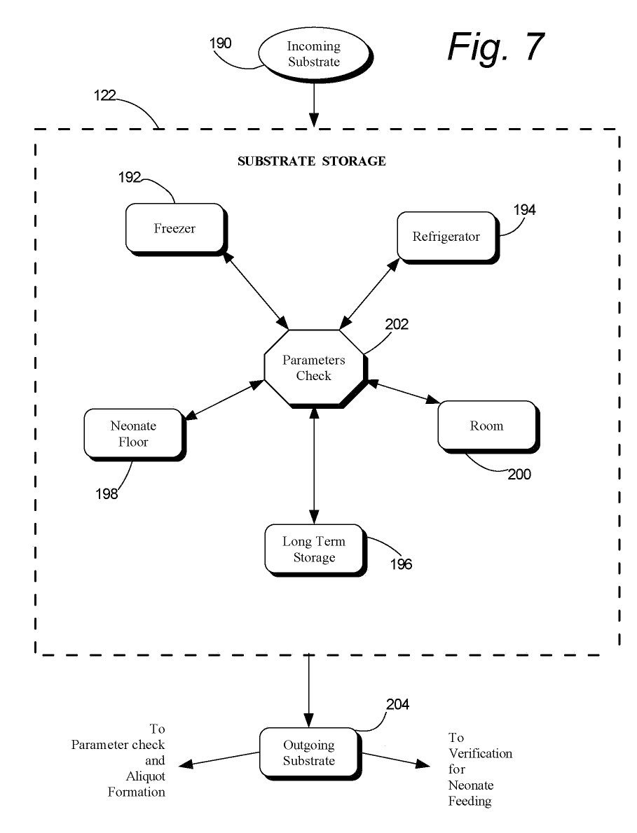

Referring now to FIG. 5, the general system and methodology for tracking the identification and physical parameters of the neonate substrate within its containers 22, 30 (FIGS. 3 and 4) will be described. The general process 100 is shown in FIG. 6 which first comprises obtaining the neonate substrate either as breast milk or as prepared formula or as a combination of both in Step 110. Once the substrate has been obtained, the individual containers in which the substrate has initially been placed are tagged with radio frequency identification devices at Step 112. It will be understood that herein after the term neonate substrate or the term substrate is used to refer to breast milk and/or to prepared formula and/or to a combination of both.

Once the RFID tag set has been initialized in step 112, the tags so initialized are registered into the data tracking system at step 112 by taking a reading of the RFID tag set for a first time by a typical RFID tag reader as is known in the art and as has been described in application Ser. No. 11/849,041. After the set of RFID tags has been initialized into the system at step 112, a portion of the tags are then provided to the mother for use in step 110 and a portion of the tags are provided to the hospital or neonate unit for use in step 120 to be discussed hereinafter. Next the containers are taken to neonate unit 114 and the check in of the containers is effected by reading the RFID tag at step 114 to update the information collected at step 112. At this point, the date of receipt of the container 22 would be noted as well as the date of obtaining the substrate from the mother if that information is available. At step 114, the received containers 22 of substrate would be generally registered into the tracking system of the hospital or neonate unit. It is from this point forward until the discarding of the container 22 that all steps of the container 22 are tracked and the temperature and identification of the container 22 are noted at each transfer or manipulation of the container 22.

In Step 112 a plurality of RFID tags are either preprogrammed or pre-associated with a mother and/or an infant for whom tracking of neonate substrate is desired. In the embodiment described herein, a passive or semi-passive RFID tag is used and the serial number or registration number of the RFID tag is correlated with identification information which corresponds to the mother or infant for whom the tags are being prepared. It will be appreciated by those skilled in the art that in the case of a semi-passive RFID tag, information can be programmed into the onboard microchip which could be information such as mother's name, infant's name, telephone numbers, room numbers, etc. It will also be appreciated that one of the features of the system and method described herein is the constant temperature monitoring of the substrate 24 (FIG. 3) as it is held within containers such as containers 22, 30. Therefore, a semi-passive RFID device may be used in the present system and method for tracking and recording the temperature status of the substrate 24. The detected information then can be downloaded by use of the radio frequency (RF) transmission when the tag is confronted with a tag reader device. It also will be appreciated that in the course of the present system and apparatus, the date on which the breast milk or infant formula is placed into the container may wish to be recorded on the microchip of the RFID tag to allow determination of an expiration date for the breast milk or infant formula. It further will be appreciated by those skilled in the art that for each mother or baby a plurality of RFID tags is prepared initially so that an abundance of RFID tags is available for any number of containers of substrate that are generated in Step 110 and which step may be repeated a number of times during the period of neonatal care.

After the RFID tags have been applied to the containers 22, 30 (FIGS. 3 and 4) and the RFID tags initialized in Step 112, the containers are moved to the neonate intensive care unit (neonate ICU) in Step 114. It will be appreciated by those skilled in the art that the containers having neonate substrate therein should not be taken to the neonate ICU area until they have been fully tagged with the RFID tags and the proper documentation of the neonate substrate made to properly incorporate the new containers of neonate substrate into the hospital and neonate ICU tracking systems for neonate substrate. As the present system of neonate substrate tracking and documentation involves numerous database recordings and correlations as between RFID tags and the hospital admission and patient identity records maintained by the hospital, the initial presence of the RFIDs in the hospital or neonate ICU database is essential. Those skilled in the art will be fully aware of the nature and extent of records that must be correlated with the RFID tags that have been applied to the neonate substrate containers generated in Step 110.

Once the containers of neonate substrate arrive at the neonate ICU, initial analysis should be performed to determine that the parameters of the newly received neonate substrate are known and documented. This analysis occurs in Step 116 during the initial parameter check. The initial parameter check 116 is similar to later parameter checks in that the particular data obtained in each case is generally the same. However, the initial parameter check provides the initial benchmark data for which changes in the neonate substrate are compared. These data are the temperature of the neonate substrate within the container and the various nutrient levels which the neonate substrate contains. Also, the weight and the volume of the amount of neonate substrate within each container is determined. These collected parameter data are sent to, and recorded by, the hospital records system via the hospital data server, either through a hardwire data transmission port or a radio frequency wireless local area network.

Once the initial parameter check has been accomplished on the newly received containers of neonate substrate, the containers may be handled in a number of different ways. One or more containers may go directly to verification step 118 which is a step prefatory to the substrate being used in actually feeding the neonate. Alternatively, the newly received containers of neonate substrate may go from initial parameter check 116 into aliquot formation 120 or to storage 122 depending upon the immediate needs for neonate substrate in the neonate ICU and the size of the containers used during the initial preparation and capture of the neonate substrate in step 110. In aliquot formation step 120, the containers of substrate originally generated in step 110 may be redispensed into containers of larger or smaller size as circumstances may require for the feeding of the particular neonate. Depending on the size of the infant and frequency of feeding, the quantity of substrate will vary and the amount of substrate in the container to be offered the neonate will vary. Aliquot formation step 120 provides the option of redispensing the neonate substrate into appropriately sized containers for the particular situation. As part of the aliquot formation step, a parameter check step 124 is utilized to verify that the weight and temperature and nutrient levels and volume of the substrate in each container is within set parameters. Also, the time and date of aliquot formation is noted, either during the aliquot formation step 120 or the coincidental parameter check 124 for recording the container data in the hospital or neonate ICU records after manipulation in Step 120.

Alternatively, after initial parameter check 116 containers of the neonate substrate prepared in step 110 may be sent immediately to storage 122. Storage 122 may either be freezing of the neonate substrate or refrigeration of the neonate substrate depending on the length of storage intended. It will be appreciated by those skilled in the art that the neonate substrate kept in storage 122 may be moved from storage 122 either to parameter check 124 and then aliquot formation 120 or to verification step 118 prefatory to use of the substrate in neonate feeding at step 126. If neonate substrate is taken from storage 122 and sent to aliquot formation 120, a parameter check 124 will be performed on the material prior to aliquot formation to track the quality of the neonate substrate after it has been held within storage 122 and prior to its manipulation during aliquot formation 120. Also, after the material taken from storage 122 has been processed through aliquot formation 120, it will again pass through parameter check 124 to provide a record of the status and contents of the container prior to being placed back into storage 122. It will be appreciated by those skilled in the art that the repeated parameter checks 124 are intended to maintain close control over the quality of the neonate substrate, to provide data regarding each container and the formula therein at each step of manipulation to ensure proper hospital procedures and to detect any failures in the steps of storage 122 or aliquot formation 120. These data also may be used to detect any change in the quality of material that has occurred since the original intake of the neonate substrate at initial parameter check 116 when the material has been received in the neonate intensive care unit 114.

As previously described, once the neonate substrate has received either an initial parameter check 116 or an aliquot formation 120 or been retrieved from storage 122, the neonate substrate will pass through verification step 118 prior to the feeding of a neonate in step 126. In step 118 it may be determined that the formula is outside of usable parameters of verification step 118, in which case the neonate substrate will be discarded in step 128. If the neonate substrate is determined to be acceptable for use in step 118, and is used for feeding of a neonate in step 126, the neonate substrate that is remaining after a feeding in step 126 then will be processed through a final parameter check 130 prior to being discarded in step 128. Parameter check 130 serves the purpose of determining the amount and quality of the neonate substrate after the step of feeding 126. In this manner, the weight and volume of substrate actually given to the neonate in 126 is documented and the quantity and nutritional content of the material remaining after feeding the neonate in step 126 is documented. These data provide the necessary information for the permanent hospital records to ensure that the neonate has actually been receiving sufficient quantity and sufficient nutrition during feedings.

Referring now to FIG. 7, the specifics of the verification protocol will be discussed. Verification protocol 150 begins in Step 152 by neonate substrate being received from parameter check 116 or aliquot formation 120 or storage 122. It will be appreciated that as verification step 118 (FIG. 6) is performed just prior to the substrate actually being fed to a neonate in step 126 that an intensive verification of the kind and quality and identification of the neonate substrate is made. This analysis begins in step 154 of the verification sequence by confirming the identification of the neonate substrate as read from the RFID tag attached to the substrate container. This is compared with the hospital records for both the baby and the mother. Should there be a discrepancy in this identification, the substrate identification discrepancy initiates alarm 156 to notify personnel that the particular container of neonate substrate has an incorrect mother/baby identification associated with it. The incorrectly identified neonate substrate then passes to an evaluation protocol 158 which is established and invoked according to the particular procedures established by the neonate intensive care unit or hospital at which the apparatus and method are in use. One result of the evaluation protocol 158 may be that the neonate substrate is discarded at step 128 (FIG. 6). If the incorrect identification alarm is raised, the information regarding this incorrect identification is transferred into hospital records at step 160a to maintain complete records and full tracking of the containers of neonate substrate. In step 154, if the check of the container radio frequency ID with the baby and/or mother information is correct, the formula then passes to step 162 for further evaluation. A record of the successful identification is made at step 160b.

In step 162, the temperature of the neonate substrate is determined to ensure it is within the acceptable temperature parameters set by the hospital protocol. If a correct temperature is detected, the container then passes to step 164 for further evaluation. If the temperature reading is out of adjustment, the neonate substrate is passed to temperature adjusting step 166. In Step 166 the substrate is warmed or cooled as needed to attain the correct feeding temperature range. It will be appreciated by those skilled in the art that the temperature adjustment of the neonate substrate is dependent upon the neonate substrate being within certain acceptable deviations of temperature which are set by hospital protocols. It will be appreciated that were the substrate found to be outside of the acceptable temperature deviation, that the substrate would be discarded. However, where the temperature is found to be within the acceptable deviation but in need of adjustment, temperature adjustment step 166 will be employed. As discussed previously, the data from each of the steps is recorded. If the correct temperature is determined in step 162, this correct temperature or, in fact, any temperature, is recorded at step 162 and is made a matter of record and recorded at step 168a. If the temperature detected at step 162 is within acceptable deviation but in need of modification, the temperature of the neonate substrate as it exists after temperature adjustment step 166 is recorded for hospital records at step 168b. After the adjusted temperature has been recorded at step 168b, the neonate substrate is passed for further analysis in step 164.

In step 164, the nutritional limits analysis is performed on the neonate substrate. This nutritional analysis examines the protein and fat and electrolyte contents of the neonate substrate to enable tracking of the nutritional parameters received by the baby during feeding step 126 (FIG. 6). If the nutritional limits detected during analysis 164 are within the set limits of the hospital, the substrate will be passed to step 170 in which the time and date and volume and weight of the neonate substrate is detected and recorded in step 172 prior to feeding in step 126. If, on the other hand, the nutritional limits analysis in step 164 determines that adjustments are to be made to the nutritional content of the substrate, the substrate will be passed to nutritional limits adjustment step 174. In step 174 modifications to electrolytes or protein or fat content can be made. Once adjustments have been made and acceptable nutritional limits are reached, the neonate substrate is passed on to step 170 for determination of volume and weight and time and date of use of the substrate. Again, it will be appreciated that in each of these steps, the data detected is recorded for hospital records. If the nutritional limits of the substrate are found to be incorrect at step 164, that information is recorded at step 176a. After nutritional adjustments are made in step 174, the adjusted nutritional limits of the neonate substrate are recorded in step 176b prior to passage of the neonate substrate to step 170. Also, if the neonate substrate has initially correct nutritional limits, as analyzed in step 164, that is recorded in step 176c prior to the particular container of the neonate substrate being passed to step 170.

Referring to FIG. 8, the treatment of a neonate substrate that is passed into storage 122 will be more fully described. In FIG. 8, a schematic representation of substrate storage 122 is shown within the dotted line box. Substrate which is sent to storage may arrive from initial parameter check 116 or from parameter check 124 subsequent to aliquot formation 120. Within the generalized storage scheme 122 of FIG. 6, a number of storage options are presented all of which are options within the present method. For example, within the general storage scheme 122, the neonate substrate may be held within a freezer 192 or a refrigerator 194 or within a long-term storage area 196. Also, variations in the storage or location may be present such as storage on the general neonate intensive care unit floor 198 or within the actual room of the mother and neonate 200. Depending on hospital protocol, it may be the case that a recheck of the neonate substrate parameters 202 is required each time the substrate is relocated. At each manipulation or transfer of the neonate substrate a parameter check may be performed, either upon the substrate going out of storage in step 204, or the substrate being transferred between freezer 192 and refrigerator 194 or from long-term storage 196 to any of room 200 or neonate floor 198 or an alternate freezer 192 or an alternate refrigerator 194. It will be appreciated that the hospital “best practices” may require a parameter check 202 to be performed any time the neonate substrate is transferred between any of these locations. The need for the parameter check may be to simply invoke a hospital identification data record that the neonate substrate has been transferred from one location to another. Alternatively, the hospital protocols may require that actual temperature, nutritional limits, and weight and volume and time and date be collected during each transfer. It will be appreciated that the present method contemplates such additional parameter checking 202 during each of these transfers or movements of the neonate substrate between locations. Finally, it will be appreciated, as shown in FIG. 6, that whenever neonate substrate is removed from the general storage scheme 122 that a parameter check 124 or a verification step 118 will be performed on the neonate substrate prior to the neonate substrate being manipulated in aliquot formation step 120 or presented to a neonate for feeding in step 126 as is represented by the options available to outgoing substrate 204 in FIG. 8.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the invention is not limited to the exact details shown or described. Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method and apparatus for container identity tracking and container temperature tracking and security is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is as follows:

1. A method of tracking a neonate feeding substrate container having feeding substrate therein comprising:
causing a radio frequency identification tag having a tag identification indica associated therewith to be attached to a neonate feeding substrate container,
entering said tag identification indicia into a neonate care database,
correlating said tag identification indicia with a neonate and/or neonate parent to provide a correlated tag identification indicia,
reading the tag identification indicia to produce a tag identification reading prior to feeding the feeding substrate to a neonate,
reporting said tag identification reading to said neonate care database.
determining if the tag identification reading corresponds to said correlated tag identification indicia to provide an authenticated container and neonate feeding substrate,
making said authenticated container and neonate feeding substrate available for feeding to a neonate.

2. The method as claimed in claim 1 further comprising the steps of:
including a temperature detector in said radio frequency identification tag,
determining a temperature of said neonate feeding substrate, and
reporting said temperature of said neonate feeding substrate to said neonate care database.

3. A method of tracking and verifying the quality of neonate feeding substrate within a container comprising:
causing a radio frequency identification tag having a tag identification indica associated therewith to be attached to a neonate feeding substrate container,
entering said tag identification indicia into a neonate care database,
correlating said tag identification indicia with a neonate and/or neonate parent to provide a correlated tag identification indicia,
reading the tag identification indicia to produce a tag identification reading prior to feeding the feeding substrate to a neonate,
measuring a parameter of said neonate feeding substrate to provide a substrate parameter reading, and
reporting said tag identification reading and said substrate parameter reading to said neonate care database.

4. The method as claimed in claim 3 wherein said parameter of said neonate feeding substrate is the feeding substrate protein content.

5. The method as claimed in claim 3 wherein said parameter of said neonate feeding substrate is the feeding substrate fat content.

6. The method as claimed in claim 3 wherein said parameter of said neonate feeding substrate is the feeding substrate electrolyte content.

7. A neonate tracking and refrigeration apparatus comprising:
a refrigeration unit for storing at least one container containing a neonate feeding substrate,
a radio frequency identification reader connected to said refrigeration unit for detecting identification data from a radio frequency identification tag having a tag identification indica associated therewith, said tag associated with a neonate feeding substrate container,
a memory for receiving said data from said radio frequency identification reader,
a display for reporting said data for review, and
a data connection for sending said data to a neonate care database

8. The apparatus as claimed in claim 7 further comprising a security lock

9. The apparatus as claimed in claim 7 wherein said data connection is a radio frequency transmitter for sending data to a neonate care database.

10. The apparatus as claimed in claim 7 wherein said data connection is a hard wire connection.

11. The apparatus as claimed in claim 7 further comprising a neonate substrate cooling and warming unit associated with said refrigeration unit and connected to said refrigeration unit by a second data connection to allow association of cooling and/or heating of said neonate feeding substrate.
